(19) United States
(12) Patent Application Publication
(10) Pub. No.: US 2010/0028744 A1
(43) Pub. Date: Feb. 4, 2010

(54) GAS DIFFUSION LAYER WITH LOWER GAS DIFFUSIVITY

(75) Inventors: CHRISTIAN WIESER, Budenheim (DE); Chunxin Ji, Pennfield, NY (US); Mark Mathias, Pittsford, NY (US); Daniel R. Baker, Romeo, MI (US); Paul D. Nicotera, Honeoye Fallls, NY (US)

Correspondence Address: Brooks Kushman P.C., 1000 Town Center, Twenty-Second Floor, Southfield, MI, 48075-1238, US

(73) Assignee: GM GLOBAL TECHNOLOGY OPERATIONS, INC., DETROIT, MI (US)

(21) Appl. No.: 12/185,640

(22) Filed: Aug. 4, 2008

(51) Int. Cl. H01M 8/10; H01M 4/86; H01M 8/02

(52) U.S. Cl. 429/30; 429/40; 429/34

(57) ABSTRACT

A gas diffusion layer for use in fuel cells comprises a fiber and non-fiber material in a ratio such that the water vapor diffusion transport resistance is greater than 0.8 s/cm measured at 80 C and 150 kPa absolute gas pressure when the gas diffusion layer has a thickness less than or equal to 300 microns. Another gas diffusion layer comprises a fiber and non-fiber material in a ratio such that the water vapor diffusion transport resistance is lower than 0.4 s/cm measured at 80 C and 150 kPa absolute gas pressure when the gas diffusion layer has a thickness greater than or equal to 100 microns. Fuel cells incorporating the gas diffusion layers are also provided.

### TECHNICAL FIELD

In at least one embodiment, the present invention is related to gas diffusion layers with reduced gas diffusivity for use in fuels cells.

### BACKGROUND

Fuel cells are used as an electrical power source in many applications. In particular, fuel cells are proposed for use in automobiles to replace internal combustion engines. In proton exchange membrane (“PEM”) type fuel cells, hydrogen is supplied as fuel to the anode of the fuel cell and oxygen is supplied as the oxidant to the cathode. The oxygen can either be in pure form (O₂) or air (a mixture of O₂ and N₂). PEM fuel cells typically have a membrane electrode assembly (“MEA”) in which a solid polymer membrane has an anode catalyst on one face and a cathode catalyst on the opposite face. The MEA is sandwiched between a pair of porous gas diffusion layers (“GDL”), which in turn are sandwiched between a pair of non-porous, electrically conductive elements or plates. These plates function as current collectors for the anode and the cathode, and contain appropriate channels and openings formed therein for distributing the fuel cell's gaseous reactants over the surfaces of the respective anode and cathode catalysts. In some cases, the GDL may be coated with a microporous layer (MPL) on the side adjacent to the catalyst layer. In order to produce electricity efficiently, the polymer electrolyte membrane of a PEM fuel cell must be thin, chemically stable, proton transmissive, non-electrically conductive and gas impermeable. In typical applications, fuel cells are stacked in series in order to provide high levels of electrical power.

Gas diffusion layers play a multifunctional role in PEM fuel cells. For example, GDL act as diffusers for reactant gases traveling to the anode and the cathode catalyst layers, while transporting product water to the flow field. GDL also conduct electrons and transfer heat generated at the MEA to the coolant, and act as a buffer layer between the soft MEA and the stiff bipolar plates. Among these functions, the water management capability of GDL is critical to enable the highest fuel cell performance. In other words, ideal GDL would be able to remove the excess product water from an electrode during wet operating conditions or at high current densities to avoid flooding, and also maintain a certain degree of membrane electrolyte hydration to obtain decent proton conductivity during dry operating conditions. The solid electrolyte membrane (such as Dupont's Nafion) used in PEM fuel cells need to be humidified to maintain a certain degree of hydration to provide good proton conductivity. Hydrocarbon based PEM, which are emerging as an alternative solid electrolyte for fuel cell applications, have the potential to be cheaper and more favorable (no fluorine release) compared to the fluoropolymer based solid electrolyte membrane such as Nafion. The hydrocarbon based solid electrolyte membranes developed to date need a higher degree of hydration in order to achieve decent proton conductivity.

For PEM fuel cells targeting automotive applications, a dryer steady state operating condition is favorable, which requires good water retention capability of the GDL to maintain a certain degree of membrane hydration. Recent studies support the assumption that the product water at the electrode leaves in vapor phase across the microporous layer (MPL), and then condenses in the GDL before evolving into the gas flow channel. For PEM fuel cells targeting automotive applications, a dryer steady state operating condition that requires good water retention capability of the GDL is favorable. The fuel cells in automotive applications will also experience wet operating conditions during start up, shut down and in a subfreezing environment.

Accordingly, there exists a need for GDL that can retain some product water under dry operating conditions, and remove excess product water during wet operating conditions for optimal function of the fuel cell.

### SUMMARY OF EXEMPLARY EMBODIMENTS OF THE INVENTION

According to an embodiment of the invention, there is provided a gas diffusion layer that is positionable between an electrode and a flow field in a PEM fuel cell. The gas diffusion layer comprises a fiber and non-fiber material in a ratio such that the water vapor diffusion transport resistance is greater than 0.8 s/cm measured at 80 C and 150 kPa absolute gas pressure when the gas diffusion layer has a thickness less than or equal to 300 microns.

According to another embodiment of the invention, there is provided a gas diffusion layer that is positionable between an electrode and a flow field in a PEM fuel cell. The gas diffusion layer comprises a fiber and non-fiber material in a ratio such that the water vapor diffusion transport resistance is lower than 0.4 s/cm measured at 80 C and 150 kPa absolute gas pressure when the gas diffusion layer has a thickness greater than or equal to 100 microns.

According to an embodiment of the invention, there is provided a fuel cell comprising an anode gas flow field having one or more channels for introducing a first gas to the fuel cell. The fuel cell further comprises an anode diffusion layer disposed over the anode gas flow field. The fuel cell further comprises an anode catalyst layer disposed over the anode diffusion layer. The fuel cell further comprises a polymeric ion conductive membrane disposed over the anode catalyst layer. The fuel cell further comprises a cathode catalyst layer disposed over the polymeric ion conductive membrane. The fuel cell further comprises a cathode diffusion layer disposed over the cathode catalyst layer. The fuel cell further comprises a cathode gas flow field having one or more cathode plate channels for introducing a second gas to the fuel cell. The cathode flow field is disposed over the cathode diffusion layer. At least one of the anode diffusion layer or the cathode diffusion layer comprises the gas diffusion layer set forth above.

According to an embodiment of the invention, there is provided a fuel cell comprising an anode gas flow field having one or more channels for introducing a first gas to the fuel cell. The fuel cell further comprises an anode diffusion layer disposed over the anode gas flow field. The fuel cell further comprises an anode catalyst layer disposed over the anode diffusion layer. The fuel cell further comprises a polymeric ion conductive membrane disposed over the anode catalyst layer. The fuel cell further comprises a cathode catalyst layer disposed over the polymeric ion conductive membrane. The fuel cell further comprises a cathode diffusion layer disposed over the cathode catalyst layer. The fuel cell further comprises a cathode gas flow field having one or more cathode plate channels for introducing a second gas to the fuel cell. The cathode flow field is disposed over the cathode diffusion layer. The anode diffusion layer and the cathode diffusion layer each independently comprise the gas diffusion layer set forth above.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a perspective view of a fuel cell incorporating the diffusion layer of an embodiment of the invention;

FIG. 2 is a schematic cross-section of a variation of the gas diffusion layer of the invention;

FIG. 3 is a schematic cross-section of a variation of the gas diffusion layer having two resin-containing layers and a microporous layer (MPL);

FIG. 4 is a schematic cross-section of a variation of the gas diffusion layer having three resin-containing layers and an MPL;

FIG. 5 provides a plot of the relationship between binder content and porosity in an embodiment of the gas diffusion layers of the invention;

FIG. 6 is a schematic diagram of a modification of a dry cup test used to determine the D/Deff ratio for the gas diffusion layers of the embodiment of the invention;

FIG. 7 provides a plot of the D/Deff ratios as a function of porosity;

FIG. 8 provides electrical voltage vs. current density plots for a fuel cell incorporating gas diffusion layers of varying binder content operating at 70% relative humidity; and

FIG. 9 provides electrical voltage vs. current density plots for a fuel cell incorporating gas diffusion layers of varying binder content operating at 25% relative humidity.

### DETAILED DESCRIPTION OF EXEMPLARY EMBODIMENTS

The following description of the embodiment(s) is merely exemplary in nature and is in no way intended to limit the invention, its application, or uses.

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

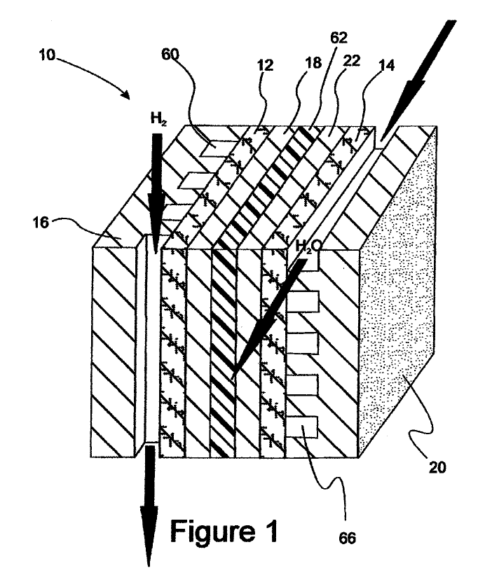

In at least one embodiment of the invention, a diffusion layer positionable between an electrode and a flow field in a PEM fuel cell is provided. With reference to FIG. 1, a perspective view of a fuel cell incorporating the diffusion layer is provided. PEM fuel cell 10 includes gas diffusion layers 12, 14. Gas diffusion layer 12 is positioned between anode flow field 16 and anode 18 while gas diffusion layer 14 is positioned between cathode flow field 20 and cathode 22.

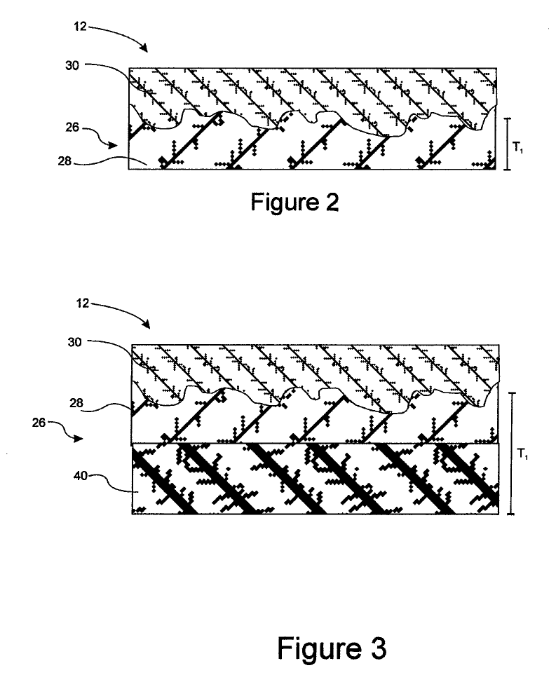

With reference to FIG. 2, a schematic cross-section of a variation of the gas diffusion layers of the present invention is provided. One or both of gas diffusion layers 12, 14 include a gas permeable diffusion structure. For example, gas diffusion layer 12 includes gas diffusion structure 26, which includes first resin-containing layer 28 comprising a plurality of fibers and a binder resin. First resin-containing layer 28 configured in this manner forms a fiber substrate. In a refinement of this embodiment, gas diffusion layer 12 includes a microporous layer (“MPL”) on one side or on both sides of diffusion layer 12. This microporous layer may or may not penetrate into the fiber substrate. FIG. 2 depicts microporous layer 30, which when used in a fuel cell is positioned adjacent to anode 18. Similarly, gas diffusion layer 14 may independently include such a resin-containing layer and microporous layer. In a refinement of the present embodiment, the microporous layer(s) comprise a carbon powder and a fluorocarbon polymer binder. Suitable fluorocarbon polymer binders include, but are not limited to, a component including at least one of PTFE, FEP, or combinations thereof.

In one embodiment of the invention, the binder resin is carbonized to be electrically conductive. In another variation of that embodiment, the binder resin is not carbonized thereby acting simply as a solid filler In either of these variations, the binder resin may be present in a first amount such that the gas diffusion layer has a ratio of water vapor free diffusion coefficient to water vapor effective diffusion coefficient greater than 1.5. In another variation, the ratio of the water vapor free diffusion coefficient to the effective diffusion coefficient may be less than or equal to 20. In yet another variation, the ratio of the water vapor free diffusion coefficient to the effective diffusion coefficient is from 3 to 15. In still another variation, the ratio of the water vapor free diffusion coefficient to the effective diffusion coefficient is from 10 to 12. In this context, the water vapor free diffusion coefficient is the diffusion coefficient of the water vapor in the gas mixture in absence of a porous material. The free diffusion coefficient, hence, represents the highest possible diffusion coefficient as the diffusive movement, and the corresponding flux of the considered gas species and the gas mixture as a whole are not restricted by a porous material. The water vapor effective diffusion coefficient in contrast describes the diffusion coefficient of the water vapor in the gas mixture in the presence of a porous material. As the porous material on one hand fills up a portion of the space that normally is accessible for diffusion and a diffusive flux (porosity effect), and on the other hand the pores usually are not straight across the porous material but inclined or wound thereby extending the path length (tortuosity effect) the effective diffusion coefficient naturally is smaller than the free diffusion coefficient. Thus, the ratio of the free diffusion coefficient to the effective diffusion coefficient D/Deff is a quantitative measure for how far the porous medium constitutes an obstacle to the diffusion and diffusive flux. Furthermore, the ratio of the free diffusion coefficient to the effective diffusion coefficient represents a bulk material property independent of the actual thickness of an actual sample and therefore is the appropriate measure to compare the diffusive mass transport resistance of different materials. The overall mass transport resistance, though, depends also on the layer thickness. This geometrical influence can be considered by multiplying the ratio of the free diffusion coefficient to the effective diffusion coefficient D/D_{eff} with the layer thickness s which is called equivalent gas layer thickness. This equivalent gas layer thickness represents the diffusion path extension if no porous material was present and, thus, is a measure for the diffusive mass transport resistance of a specific sample with its given thickness. For a typical gas diffusion layer with 200 μm uncompressed thickness the above mentioned D/D_{eff} ratio of 10 to 12 translates into an equivalent gas layer thickness of 2.0 to 2.4 mm. However, typical gas diffusion layer like 200 μm Toray TGP060 exhibit D/D_{eff} of 3-4 in an uncompressed situation. In one embodiment the porosity of the diffusion layer may range from 25 volume % to 95 volume % whereas typical state-of-the-art diffusion layer exhibit porosities between 75% and 85%.

As set forth above, the binder resin is present in a first amount such that the gas diffusion layer has a sufficiently high ratio of water vapor free diffusion coefficient to water vapor effective diffusion. To this end, the carbonized binder resin is present in an amount from 18 wt % to 60 wt % (and ranges there between including, but not limited to 18 wt % to 60 wt %, 18 wt % to 30 wt %, and 30 wt % to 60 wt %) whereas uncarbonized resin can be present in even higher portions up to 80% and further (for higher D/D_{eff} ratios) which is due to the fact that the resin loses mass during the heat treatment necessary for carbonization. Even higher than 60 wt % carbonized binder resin may be achieved by subsequent resin impregnation and succeeding carbonization. The resin-containing layer may include carbon fiber woven or non-woven textile or paper or a carbon cloth. The high amount of resin advantageously results in a decrease in porosity with a concurrent gain in tortuosity. An increase in binder content is found to reduce the effective diffusion coefficient (or increase the D/D_{eff} ratio). The binder resin fixes the loose fibers together thereby ensuring low electrical and thermal contact resistances between contacting fibers and across the gas diffusion layer 12. However, as the binder also affects GDL structural properties, increasing binder content (at given fiber content) decreases the GDL porosity E (i.e. the dimensionless ratio of pore volume to the total volume) and increases its tortuosity r (by definition this is the square of the dimensionless ratio of the actual path length in the tortuous pore to the straight path length). This results in an increase in diffusive mass transport resistance. Moreover, if the resin, which is a polymer, is not carbonized (carbonization may increase thermal and electric conductivity and maintain the mechanical properties of the GDL) the effect may be even more pronounced as the resin loses mass during carbonization. The relationship between D/Deff and porosity and tortuosity, respectively, is provided by the following formula:

$$\frac{D}{{D}_{eff}} = \frac{τ}{ɛ}$$

Accordingly, as the porosity decreases and the tortuosity increases, the D/Deff ratio increases and, thus, the diffusive mass transport resistance for a given layer thickness also increases. Consequently, the controlled design of the porosity and the tortuosity of a diffusion layer impact the mass transport resistance of a diffusion layer and, thus, porosity and tortuosity control relate to material development and adaptation of the material's mass transport properties to the operation requirements, as will be shown later. The binder resin content may be used to aid in controlling porosity and tortuosity and, hence, mass transport resistance. By increasing the binder content the voids between the fibers, in other words, the porosity, get smaller and the porosity decreases. The gas has less void space and cross-sectional area to move across the diffusion layer. At the same time, the binder increasingly spreading out within the diffusion layer reduces the number of straight diffusion paths and forces the gas to make “detours”, i.e. the gas moving through the diffusion layers has to move along a more and more tortuous path which may result in a prolongation of the overall diffusion path across the diffusion layer. Both combined translate into a higher mass transport resistance. As outlined before, the D/Deff ratio represents a bulk material property independent of the actual thickness of an actual sample and therefore is the appropriate measure to compare the diffusive transport resistance of different materials. The overall mass transport resistance may also be used to compare different materials, but the test conditions (temperature, gas pressure), gas species (water vapor or oxygen), and layer thickness must be specified. Gas transport resistance is defined as “f*h/D_{eff}”, with units of seconds per centimeter, where “f” is a geometrical factor to account for land-channel geometry if the measurement is done in a fuel cell configuration, “h” is the layer thickness, and “D_{eff}” is the effective diffusion coefficient as defined above. Derivation of the gas transport resistance term is described in the reference “D. Baker, C. Wieser, K. C. Nyerlin, and M. W. Murphy, “The Use of Limiting Current to Determine Transport Resistance in PEM Fuel Cells,” ECS Transactions, Vol. 3, pp. 989-999 (2006). The entire disclosure of this reference is hereby incorporated by reference.

In a variation of the present embodiment, the gas diffusion layer comprising a fiber and non-fiber material in a ratio such that the water vapor diffusion transport resistance is greater than 0.8 s/cm measured at 80 C and 150 kPa absolute gas pressure when the gas diffusion layer has a thickness less than or equal to 300 microns. In another refinement of the present invention, the diffusion transport resistance is greater than 1.0 s/cm at the same conditions. In still another refinement, the diffusion transport resistance is greater than 1.2 s/cm at the same conditions. In yet another refinement of the present embodiment, the diffusion transport resistance is less than 3.0 s/cm.

In another variation of the present embodiment, the gas diffusion layer comprising a fiber and non-fiber material in a ratio such that the water vapor diffusion transport resistance is less than 0.4 s/cm measured at 80° C. and 150 kPa absolute gas pressure when the gas diffusion layer has a thickness greater than or equal to 100 microns. In another refinement of the present invention, the diffusion transport resistance is less than 0.3 s/cm at the same conditions. In still another refinement, the diffusion transport resistance is less than 0.2 s/cm at the same conditions. In yet another refinement of the present embodiment, the diffusion transport resistance is greater than 0.05 s/cm.

Gas permeable diffusion structure 26 can be formed from virtually any material having suitable porosity and chemical stability. Examples of suitable materials having the requisite properties include, but are not limited to, woven or non-woven textile or paper. Typical thicknesses T₁ for gas permeable diffusion structure 26 are from 50 microns to 500 microns.

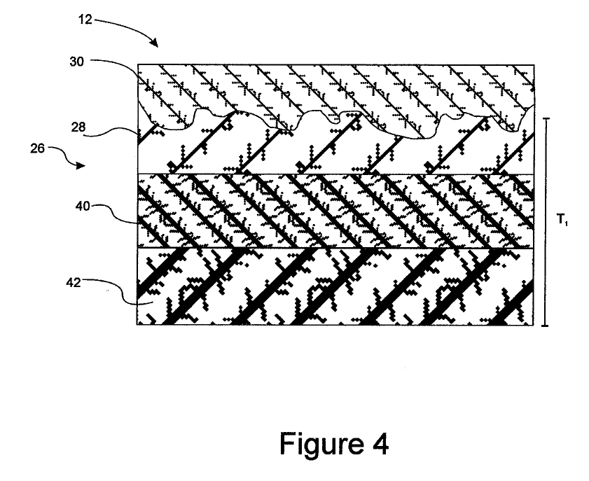

With reference to FIGS. 3 and 4, schematic cross-sections of another embodiment of the invention in which a gas diffusion layer includes multiple resin-containing layers are provided. In this embodiment, one or both of gas diffusion layers 12, 14 may include a multiple layer gas permeable diffusion structure. With reference to FIG. 3, a schematic cross-section of a variation having two resin-containing layers is provided. Gas diffusion layer 12 includes gas diffusion structure 26 and optional MPL layer 30. In this embodiment gas diffusion structure 26 includes first resin-containing layer 28 and second resin containing layer 40. First resin-containing layer 28 includes a resin present in a first amount. Second resin containing layer 40 includes a resin present in a second amount that is more than the first amount. With reference to FIG. 4, a schematic cross-section of a variation having three resin-containing layers is provided. Gas diffusion layer 12 includes gas diffusion structure 26 and optional MPL layer 30. Gas diffusion structure 26 includes first resin-containing layer 28, second resin containing layer 40, and third resin-containing layer 42. In this variation, second resin-containing layer 28 has a lower resin content than either or both of first resin-containing layer 40 and third resin-containing layer 42. In a specific refinement, resin-containing layer 40 having a higher resin content than resin-containing layers 28, 42. It should be appreciated that either of the variations of FIGS. 3 and 4 may include one or more additional resin containing layers with each individual layer having a different content of carbonized or uncarbonized binder resin. Besides each individual layer having different contents of carbonized or uncarbonized binder resin, each individual layer may also have different fiber contents.

With reference to FIGS. 1, 2, 3, and 4, a fuel cell that incorporates the diffusion layers of the invention set forth above is provided. Fuel cell 10 of this embodiment includes anode gas flow field 16, which typically includes one or more channels 60 for introducing a first gas to the fuel cell 10. Anode diffusion layer 12 is disposed over anode gas flow field 16 while anode catalyst layer 18 is disposed over the anode diffusion layer 12. Polymeric ion conductive membrane 62 is disposed over anode catalyst layer 18. Cathode catalyst layer 28 is disposed over polymeric ion conductive membrane 62. Cathode diffusion layer 14 is disposed over cathode catalyst layer 22. Finally, cathode gas flow field 20 is disposed over cathode diffusion layer 14. Cathode gas flow field 20 includes one or more channels 66 for introducing a second gas into fuel cell 10. At least one of the anode diffusion layer 12 or the cathode diffusion layer 14 comprises a gas permeable diffusion structure 26. Gas permeable diffusion structure 26 includes one or multiple resin-containing layers comprising a plurality of fibers, and a carbonized or uncarbonized binder resin with or without a microporous layer on one or both sides of the gas diffusion layer as set forth above. The binder resin may be present in the same or in different amounts in the one or multiple layers of the gas diffusion layer such that the gas diffusion layer has a ratio of water vapor free diffusion coefficient to water vapor effective diffusion coefficient is greater than 1. The details and variations of gas permeable diffusion structure 26 are the same as those set forth above.

The following examples illustrate the various embodiments of the present invention. Those skilled in the art will recognize many variations that are within the spirit of the present invention and scope of the claims.

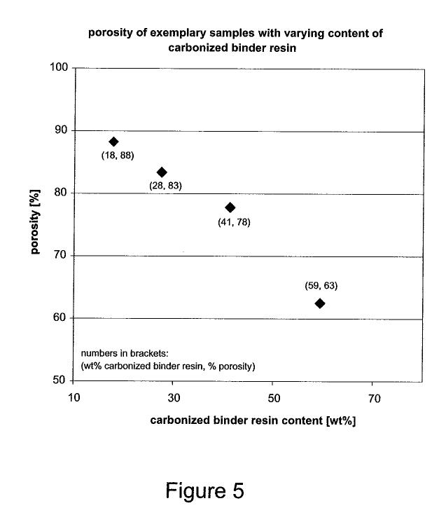

Gas diffusion layer samples with different binder contents are as follows. A fiber mat with a density of about 35 g/m² is prepared by a traditional paper making process using Sigrafil C-30. Polyvinyl alcohol is used as a temporary binder. Various amounts of phenolic resin are impregnated into the above fiber mat through a solvent incorporating process. The impregnated carbon fiber paper is further molded to the same thickness and carbonized at about 2350° C. FIG. 5 plots the relationship between binder content and porosity in the samples. In general, as the binder content increases, the porosity decreases.

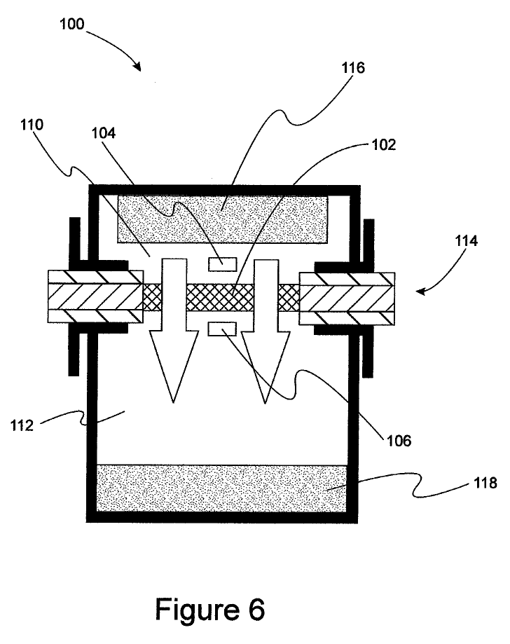

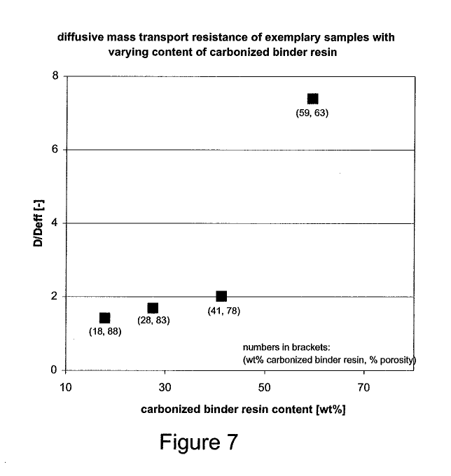

The water vapor diffusivities of the samples are measured using a modified version of the cup-methods described in ASTM E-96 and EN ISO 12572. Since fuel cell diffusion media exhibit comparably low diffusion resistances (thin, small diffusion resistance number D/D_{eff}) the standard methods are very inaccurate. With reference to FIG. 6, a schematic illustration of the modified dry cup method used to determine water vapor diffusivities is provided. FIG. 6 shows that the dry cup test system 100 measures the relative humidity gradient across the sample 102 is measured with calibrated relative humidity sensors 104, 106 in order to determine the local relative humidity at defined positions on both sides of sample 102. This relative humidity gradient results from water vapor flux 108 from humid compartment 110 to dry compartment 112. Humid compartment 110 and dry compartment 112 are separated by the porous sample thereby forcing the entire diffusive water vapor flux through the sample. Gasket 114 ensures tightness to the ambience to avoid loss of water vapor out of the system, which would create an error of the measurement. Reservoir 116 provides a source of humidity in humid compartment 110 while desiccant 118 assists in keeping dry compartment 112 relatively dry. By using Fick's first law of diffusion and measuring the RH gradient as well as the mass increase in the dry compartment after the test, for a given geometry (cross-section, sensor distance, sample thickness) the effective diffusion coefficient of water vapor in the porous sample can be calculated. FIG. 7 provides a plot of the D/Deff ratios as a function of porosity. The D/Deff clearly falls as the binder content decreases and porosity increases.

The following table depicts the relationship of the increasing binder resin content and the resulting decrease in porosity and increase in tortuosity. Both effects combined increase the mass transport resistance as being shown the increasing D/Deff numbers with increasing binder resin content. Since tortuosity cannot be measured or determined in structures as complex as fuel cell diffusion media, it has been back-calculated using the above equation. Furthermore, these exemplary samples have been obtained by completely carbonizing the phenolic resin. An increase of the porosity, tortuosity and D/Deff range can be expected by further adding uncarbonized resin with possible, but not necessary, further carbonization.

| | phenolic | carbonized | measured | measured | calculated |
|---|---|---|---|---|---|
| | resin | binder | porosity | D/D_{eff} | tortuosity |
| Sample No. | [wt %] | [wt %] | [%] | [—] | [—] |
| 1 | 30 | 18 | 88 | 1.4 | 1.3 |
| 2 | 43 | 28 | 83 | 1.7 | 1.4 |
| 3 | 58 | 41 | 78 | 2.0 | 1.6 |
| 4 | 75 | 59 | 63 | 7.4 | 4.6 |

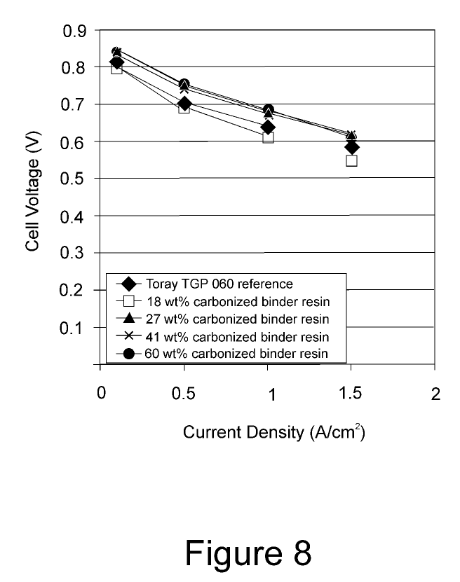

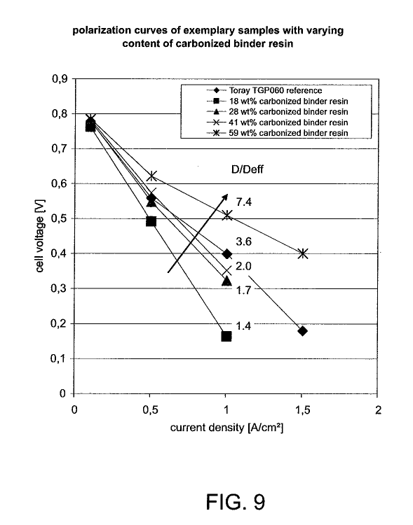

The performance of the gas diffusion layers is evaluated as follows. The samples are wet-proofed by standard methods and tested in a fuel cell under both humid and dry operating conditions, as shown in FIGS. 8 and 9. FIG. 8 provides current versus voltage plots for a fuel cell incorporating gas diffusion layer of varying binder content operating at 70% relative humidity while FIG. 9 provides current-voltage plots for a fuel cell incorporating gas diffusion layer of varying binder content operating at 25% relative humidity. The fuel cells are assembled with a 5 cm² straight channel flow field using a Gore 5510 MEA and operated at 80° C. and 150 kPa-abs under high anode and cathode stoichiometries. This set-up with these operating conditions is known as a differential cell test wherein it can be assumed that the operating conditions (and particularly reactant concentrations and RH) are constant along the channel in the measurement area. As a control, a regular Toray TGP060 is used. At comparatively humid conditions (70% RH, FIG. 8) there is no performance difference that can be attributed to the water vapor retention effect expected with the different GDL. At dry conditions (25% RH, FIG. 9), however, there is a very distinct spread of the polarization curves. The spread of the plots correlates directly to the diffusion properties of the GDLs giving the best dry performance for the GDL materials with the highest D/D_{eff} ratios and vice versa. This performance benefit is already visible with Gore membranes. It has to be mentioned that the humidity related (GDL related) performance changes and differences are not only due to changed membrane performance but also due to effects in the electrodes. In one embodiment of the invention the diffusion layer is constructed and arranged so that the binder resin increases the tortuosity for gas moving through the diffusion layer, wherein the tortuosity is between about 1.5 and about 20.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A gas diffusion layer that is positionable between an electrode and a flow field in a PEM fuel cell, the gas diffusion layer comprising a fiber and non-fiber material in a ratio such that the water vapor diffusion transport resistance is greater than 0.8 s/cm measured at 80 C and 150 kPa absolute gas pressure when the gas diffusion layer has a thickness less than or equal to 300 microns.

2. The diffusion layer of claim 1 wherein the diffusion transport resistance is greater than 1.0 s/cm

3. The diffusion layer of claim 1 wherein the diffusion transport resistance is greater than 1.2 s/cm.

4. The diffusion layer of claim 1 wherein the diffusion transport resistance is less than 3.0 s/cm.

5. The diffusion layer of claim 1 wherein the binder resin is carbonized to be electrically conductive.

6. The diffusion layer of claim 1 wherein the binder resin is non-carbonized to act as a solid filler.

7. The diffusion layer of claim 1 wherein the binder resin comprises a combination of carbonized and non-carbonized resin.

8. The diffusion layer of claim 5 wherein the carbonized binder resin is present in an amount of from between about 18 wt % and about 60 wt %.

9. The diffusion layer of claim 1 having a porosity in an amount from between about 25 volume % and about 95 volume %.

10. The diffusion layer of claim 9 having a porosity in an amount from between about 60 volume % and about 89 volume %.

11. The diffusion layer of claim 1 wherein the fibers of the gas permeable diffusion structure comprise a woven or non-woven textile or paper.

12. The diffusion layer of claim 1 wherein the resin-containing layer comprises carbon fiber woven or non-woven textile or paper or a carbon cloth.

13. The diffusion layer of claim 1 further comprising a second resin-containing layer comprising a plurality of fibers and a binder resin having a resin present in a second amount that is different from the resin amount in the first layer.

14. The diffusion layer of claim 1 further comprising one or more additional resin containing layers each individual resin-containing layer arranged adjacent the next individual resin-containing layer with each individual layer having a different content of resin from the next adjacent resin-containing layer.

15. The diffusion layer of claim 1 further comprising a microporous layer on at least one side of the first resin-containing layer.

16. The diffusion layer of claim 15 wherein the microporous layer comprises a carbon powder and a fluorocarbon polymer binder.

17. The diffusion layer of claim 16 wherein the fluorocarbon polymer binder comprises a component comprising at least one of PTFE, FEP, or combinations thereof.

18. A gas diffusion layer that is positionable between an electrode and a flow field in a PEM fuel cell, the gas diffusion layer comprising a fiber and non-fiber material in a ratio such that the water vapor diffusion transport resistance is lower than 0.4 s/cm measured at 80 C and 150 kPa absolute gas pressure when the gas diffusion layer has a thickness greater than or equal to 100 microns.

19. The diffusion layer of claim 18 wherein the diffusion transport resistance is lower than 0.3 s/cm

20. The diffusion layer of claim 18 wherein the diffusion transport resistance is less than 0.2 s/cm.

21. The diffusion layer of claim 18 wherein the diffusion transport resistance is greater than 0.05 s/cm.

22. The diffusion layer of claim 18 wherein the binder resin comprises a component selected from the group consisting of carbonized electrically conductive resins, non-carbonized resins, and combinations thereof.

23. The diffusion layer of claim 1 further comprising one or more additional resin containing layers each individual resin-containing layer arranged adjacent the next individual resin-containing layer with each individual layer having a different content of resin from the next adjacent resin-containing layer.

24. The diffusion layer of claim 1 further comprising a microporous layer on at least one side of the first resin-containing layer.

25. The diffusion layer of claim 15 wherein the microporous layer comprises a carbon powder and a fluorocarbon polymer binder.

26. A fuel cell comprising:
an anode gas flow field having one or more channels for introducing a first gas to the fuel cell,
an anode diffusion layer disposed over the anode gas flow field;
an anode catalyst layer disposed over the anode diffusion layer;
a polymeric ion conductive membrane disposed over the anode catalyst layer;
a cathode catalyst layer disposed over the polymeric ion conductive membrane;
a cathode diffusion layer disposed over the cathode catalyst layer;
a cathode gas flow field having one or more cathode plate channels for introducing a second gas to the fuel cell, the cathode flow field being disposed over the cathode diffusion layer, wherein at least one of the anode diffusion layer or the cathode diffusion layer comprises:
gas diffusion layer comprising a fiber and non-fiber material in a ratio such that the water vapor diffusion transport resistance is greater than 0.8 s/cm measured at 80 C and 150 kPa absolute gas pressure when the gas diffusion layer has a thickness less than or equal to 300 microns or such that the water vapor diffusion transport resistance is lower than 0.4 s/cm measured at 80 C and 150 kPa absolute gas pressure when the gas diffusion layer has a thickness greater than or equal to 100 microns.
